(19) United States
(12) Patent Application Publication
(10) Pub. No.: US 2012/0200609 A1
(43) Pub. Date: Aug. 9, 2012

(54) METHOD FOR DRIVING A LIQUID CRYSTAL DISPLAY DEVICE

(76) Inventors: Hak-Mo CHOI, Seoul (KR); Tae Kwon JUNG, Asan-si (KR); Dae-Gwang JANG, Gyeyang-gu (KR); Dong Hak PYO, Cheonan-si (KR); Min Ha KEUM, Cheonan-si (KR)

(21) Appl. No.: 13/243,151

(22) Filed: Sep. 23, 2011

(30) Foreign Application Priority Data
Feb. 7, 2011 (KR) 10-2011-0010744

(51) Int. Cl. G09G 5/10; G09G 3/36

(52) U.S. Cl. 345/690; 345/87

(57) ABSTRACT

A driving method of a liquid crystal display is provided for improving an echo phenomenon in the screen and improving crosstalk in a 3D display device. The liquid crystal display includes a liquid crystal panel and a light source unit divided into a plurality of blocks and that irradiates light by a light source unit of the corresponding block being driven at a response time of liquid crystals of the liquid crystal panel. Data of a liquid crystal panel corresponding to the plurality of blocks is analyzed to determine an n-th block corresponding to a portion having the highest visibility. Driving periods of light source units of the n-th block, an (n−1)-th block, and an (n+1)-th block are synchronized.

### CROSS-REFERENCE TO RELATED APPLICATION

This application claims priority to and the benefit of Korean Patent Application No. 10-2011-0010744 filed in the Korean Intellectual Property Office on Feb. 7, 2011, the entire contents of which are incorporated by reference herein.

### BACKGROUND OF THE INVENTION

(a) Field of the Invention

The present disclosure relates to a driving method of a liquid crystal display, and more particularly, to a driving method of a liquid crystal display for improving an echo phenomenon and crosstalk in the display device.

(b) Discussion of the Related Art

A liquid crystal display is one of a family of flat panel displays that are widely used and includes two display panels where field generating electrodes, such as a pixel electrode and a common electrode, are formed with a liquid crystal layer interposed therebetween. The liquid crystal display generates an electric field in a liquid crystal layer by applying a voltage to the field generating electrodes to determine directions of liquid crystal molecules of the liquid crystal layer and to control polarization of incident light, thereby displaying an image.

Such a liquid crystal display is not self-emissive and requires a light source. The light source may be an additionally provided artificial light source or natural light. An artificial light source used in the liquid crystal display may include a light emitting diode (LED), a cold cathode fluorescent lamp (CCFL), and an external electrode fluorescent lamp (EEFL).

Recently, a method for dividing the light source into a plurality of blocks and sequentially driving the blocks has been researched. When the light sources are sequentially driven, the driving of neighboring blocks can be different from each other. Thus, when light sources of neighboring blocks are driven when a light source of the corresponding block is not driven the corresponding block can be interfered with.

### SUMMARY OF THE INVENTION

Exemplary embodiments of present invention provide a driving method of a liquid crystal display that can minimize the influence of light source units of neighboring blocks when driving a light source unit that has been divided into a plurality of blocks.

In addition, exemplary embodiments of the present invention provide a driving method of a liquid crystal display to improve an echo phenomenon in a screen and improve a crosstalk phenomenon in the display device.

According to an exemplary embodiment, a driving method of a liquid crystal display including a liquid crystal panel and a light source unit divided into a plurality of blocks and configured to irradiate light by a light source unit of a corresponding block being driven at a response time of liquid crystals of the liquid crystal panel, is provided. Data of a liquid crystal panel corresponding to the plurality of blocks is analyzed to determine an n-th block corresponding to a portion having a highest visibility. Driving periods of light source units of the n-th block, an (n−1)-th block, and an (n+1)-th block are synchronized.

The driving periods of the light source units of the (n−1)-th block and the (n+1)-th block may be synchronized with the driving period of the n-th block.

Data of the liquid crystal panel corresponding to the (n−1)-th block may have a highest luminance among data of the liquid crystal panels corresponding to the plurality of blocks.

Data of the liquid crystal panel corresponding to the n-th block may have a highest luminance difference between a previous frame and a present frame among data of the liquid crystal panels corresponding to the plurality of blocks.

The driving method of claim may further include analyzing data of the liquid crystal panel to set a driving period for driving the light source unit.

A length of the driving period of the light source unit may be shortened as a luminance value of the data is decreased.

The lengths of driving periods of a light source of each of the plurality of blocks may be equivalent to each other.

The length of a driving period of a light source of a block may be set to be short as a luminance value of data of a liquid crystal panel corresponding to the block is decreased.

The length of a driving period of a light source unit of at least one block may be different from the length of a driving period of a light source unit of another block.

The light source unit may be disposed at one side of the liquid crystal panel.

A first light source unit may be disposed at one side and a second light source may be disposed at an opposing side of the liquid crystal panel.

The first light source unit and the second light source unit respectively may be divided into two regions, and light source units of a plurality of blocks included in each region may be independently driven.

The light source unit may be disposed at a lower side of the liquid crystal panel.

The light source unit may be divided into a plurality of regions, and light source units of a plurality of blocks included in each region may be independently driven.

The light source unit may be formed of at least one of a light emitting diode (LED), an organic light emitting diode (OLED), a cold cathode fluorescent lamp (CCFL), and an external electrode fluorescent lamp (EEFL).

According to an exemplary embodiment a driving method of a liquid crystal display including a liquid crystal panel and a light source divided into a plurality of blocks and configured to irradiate light by a light source unit of a corresponding block at a response time of liquid crystals of the liquid crystal panel, is provided. Data of a liquid crystal panel corresponding to the plurality of blocks is analyzed to determine a target block. A driving period for driving a light source unit of the target block and driving periods for diving light source units of blocks neighboring the target block are synchronized.

The target block may be a block corresponding to a portion having a highest visibility in the liquid crystal panel.

Multiple target blocks may be provided.

M blocks may be determined as target blocks in sequence from the highest visibility in the liquid crystal panel.

The effect of the driving method of the liquid crystal display is as follows.

The driving method of the liquid crystal display according to the present invention divides a light source unit into a plurality of blocks for driving and synchronizes a driving period of a light source of a block corresponding to a portion having the highest visibility and driving periods of light source units of neighboring blocks to minimize the influence from the light source units of the neighboring blocks.

Accordingly, the echo phenomenon in the screen can be improved, and particularly, the crosstalk phenomenon in the display device can be improved.

### BRIEF DESCRIPTION OF THE DRAWINGS

FIG. 1 is an exploded perspective view of a liquid crystal display to which the present invention is applied.

FIG. 2 is a flowchart of a driving method of a liquid crystal display according to an exemplary embodiment of the present invention. FIG. 3 and FIG. 4 show driving timing of each block of a light source unit in the driving method of the liquid crystal display according to an exemplary embodiment of the present invention.

FIG. 5 is a flowchart of a driving method of a liquid crystal display according to an exemplary embodiment of the present invention.

FIGS. 6, 7 and 8 show driving timing of each block of a light source unit of the driving method of the liquid crystal display according to an exemplary embodiment of the present invention.

FIG. 9 and FIG. 10 show driving timing of each block of a light source unit of a driving method of a liquid crystal display according to an exemplary embodiment of the present invention.

FIGS. 11, 12 and 13 show application examples of driving methods of liquid crystal displays of the present invention according to the type of light source unit.

FIG. 14 is a graph showing the degree of an echo phenomenon according to the driving method of the liquid crystal display of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

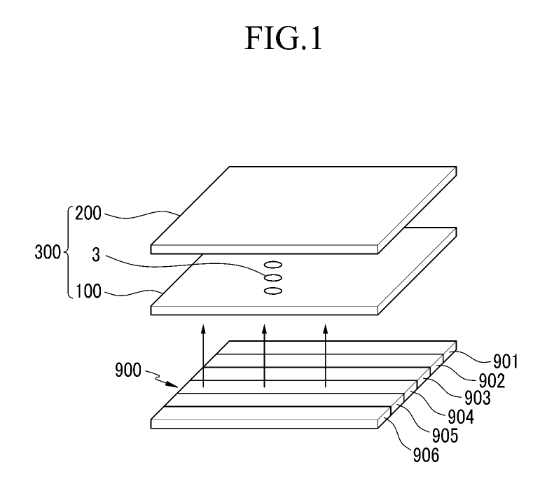

Referring first to FIG. 1, a liquid crystal display to which the present invention can be applied is formed of a liquid crystal display panel 300 and a light source unit 900 that irradiates light to the liquid crystal panel 300.

The liquid crystal panel 300 includes a first substrate 100, a second substrate 200, and a liquid crystal layer 3 interposed between the two substrates, the two substrates 100, 200 facing each other. Gate lines and data lines that cross each other (not shown) and a thin film transistor (not shown) connected to a gate line and a data line are formed in the first substrate 100. Further, a pixel electrode connected to the thin film transistor is formed on the first substrate 100 and a common electrode is formed on the first substrate 100 or the second substrate 200. An electric field formed between the pixel electrode and the common electrode determines the alignment of liquid crystal molecules of the liquid crystal layer 3.

The light source unit 900 is disposed at a lower side of the liquid crystal panel 300 and irradiates light to the liquid crystal panel 300. A predetermined percentage of the irradiated light may be emitted to the outside of the liquid crystal panel 300 according to the alignment of the liquid crystal molecules.

The light source unit 900 is partitioned into a plurality of blocks aligned substantially in the same direction as the gate lines (not shown). The light source units 900 of respective blocks are sequentially driven. That is, the light source units 900 of the respective blocks are driven at different times. Further, the light source unit 900 of a corresponding block is driven taking into consideration the response timing of the liquid crystals of the liquid crystal panel 300.

A predetermined time period (delay) occurs before the liquid crystals respond after the pixel electrode and the common electrode are applied with voltages. Thus, when a motion picture is displayed on the liquid crystal panel, an afterimage of the previous frame remains on the screen of the present frame such that an echo phenomenon occurs. To minimize such echo phenomenon, the light source unit 900 is divided into a plurality of blocks and a light source unit 900 of the corresponding block is driven for light irradiation taking into consideration the response time of liquid crystals of the liquid crystal panel 300 corresponding to each block. The light source unit 900 of the corresponding block is then stopped after a predetermined time lapse to stop irradiation of light.

The echo phenomenon can be further improved as the number of blocks partitioning the light source unit 900 increases. However, since the neighboring blocks have different driving timing, a block not in a driven state can be interfered with by light of the neighboring blocks in the driven state such that the echo phenomenon is less improved.

In accordance with exemplary embodiments of the present invention, driving timing of the light source units 900 of specific blocks are synchronized to reduce the interference of the light of the neighboring blocks.

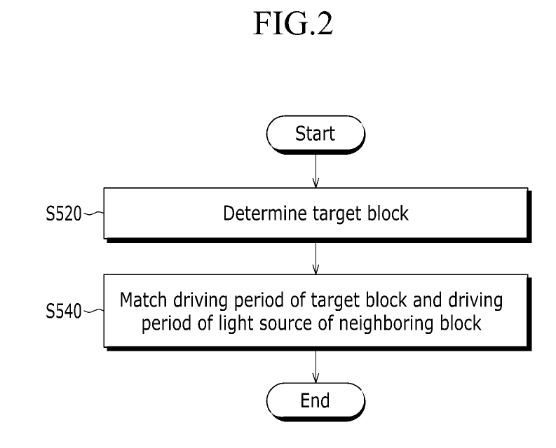

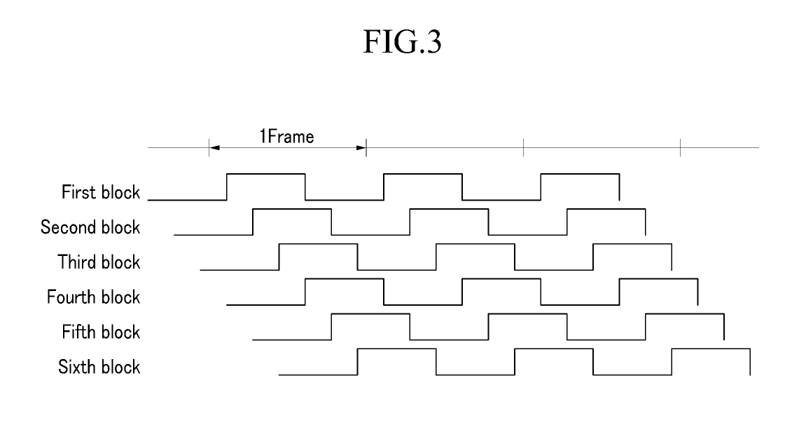

Referring now to FIG. 2, data of a liquid crystal panel corresponding to the plurality of blocks is analyzed and a block corresponding to a portion having high visibility, that is, a portion that is better viewed by human eyes, is determined as a target block (S520).

Then, a driving period of a light source unit 900 of the target block and light source units 900 of neighboring blocks are synchronized (S540).

Hereinafter, each step of the driving method will be described in further detail with reference to FIG. 3 and FIG. 4.

In an exemplary embodiment the light source unit 900 is divided into 6 blocks, and as shown in FIG. 3, a first block light source unit 901 to a sixth block light source unit 906 are set to be sequentially driven in one frame. The first block light source unit 901 to the sixth block light source unit 906 are also set to be sequentially driven in the next frame.

Data corresponding to the first to sixth blocks of the liquid crystal panel 300 are respectively analyzed, and a block corresponding to a portion that is better recognized by human eyes than other periphery areas in the screen of one frame, that is, a portion having the highest visibility, is determined as a target block. The portion having the highest visibility is further highly influenced by light of neighboring blocks, and thus the echo phenomenon of the portion may be particularly recognized. Compared to other portions, the portion having the highest visibility may have the highest luminance value (i.e., visually perceived brightness) among data of the liquid crystal panel. For example, in a color image, the luminance value can be found by a weighted sum such as: luminance=0.27 red+0.67 green+0.06 blue.

In this case, to determine a block corresponding to the portion having the highest visibility, an average value of luminance of data of the liquid crystal panel corresponding to the first block is operated and the average value is generated as a representative value of the first block. Likewise, the same operation is performed to the second to sixth blocks to generate representative values of the second to sixth blocks. The representative value of the first block and the representative value of the sixth block are compared to determine a block having the highest representative value as the block corresponding to the portion having the highest visibility.

In addition, compared to other portions, a portion having high visibility may be a portion having the highest difference between luminance values of the present frame data and the previous frame data. In this case, to determine a block corresponding to a portion having the highest visibility, a luminance difference between previous frame data and the present frame data of the liquid crystal panel 300 corresponding to the first block and an average value of the differences are operated to generate the average value as a representative value of the first block. Likewise, the same operation is performed from the second to sixth blocks to generate a representative value of the second block to a representative value of the sixth block. The representative value of the first block to the representative value of the sixth block are compared to each other and a block having the largest representative value may be determined as a block corresponding to a portion having the highest visibility.

When the third block is determined as a block corresponding to a portion having the highest visibility using the above-described methods, a driving period of third block light source unit 903, a driving period of a second block light source unit 902, and driving periods of neighboring block light source units 903, 904, that is, the second block and the fourth block, are synchronized as shown in FIG. 4. A portion marked by the dotted line in the drawing denotes driving timing before synchronization of the driving periods of the light source units 902, 903, 904 of the second to fourth blocks, and a portion marked by the solid line denotes driving timing after the synchronization.

To synchronize the driving periods of the light source units 902, 903, 904 of the second to fourth blocks, the light source units 902, 903, 904 may be simultaneously driven at a time that the liquid crystals of the liquid crystal panel 300 corresponding to the second block respond and then they may be simultaneously stopped after a predetermined time period lapse. In addition, the driving periods of the second to fourth block light source units 902, 903, 904 may be synchronized at a response time of the liquid crystal of the liquid crystal panel 300 corresponding to the third block or a response time of the liquid crystal of the liquid crystal panel 300 corresponding to the fourth block.

In this case, since a portion corresponding to the third block has the highest visibility, in an exemplary embodiment the driving periods of the light source units 902, 903, 904 of the second to fourth blocks are synchronized at the response time of the liquid crystal of the liquid crystal panel 300 corresponding to the third block. Light irradiated from neighboring blocks does not interfere with the third block that corresponds to a portion having the highest visibility during a period in which the third block light source unit 903 is not driven such that the echo phenomenon can be improved.

In the exemplary embodiment depicted in FIG. 4, the driving periods of light source units 900 of the first and following frames are synchronized with reference to the third block, but exemplary embodiments of the present invention are not limited thereto. That is, when a portion having the highest visibility is changed to the next block in the next frame, the driving periods of light source units 900 can be synchronized with reference to the changed block.

In an exemplary embodiment of the present invention, the light source unit 900 can be divided into 6 blocks, but exemplary embodiments of present invention are not limited thereto. That is, the light source unit 900 may be divided into less than or more than 6 blocks.

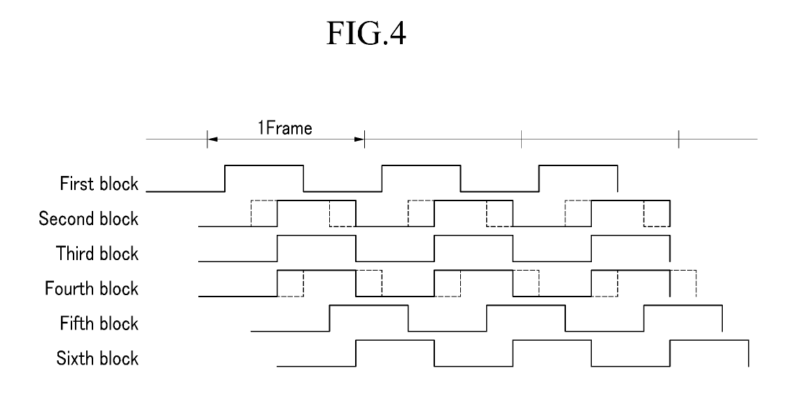

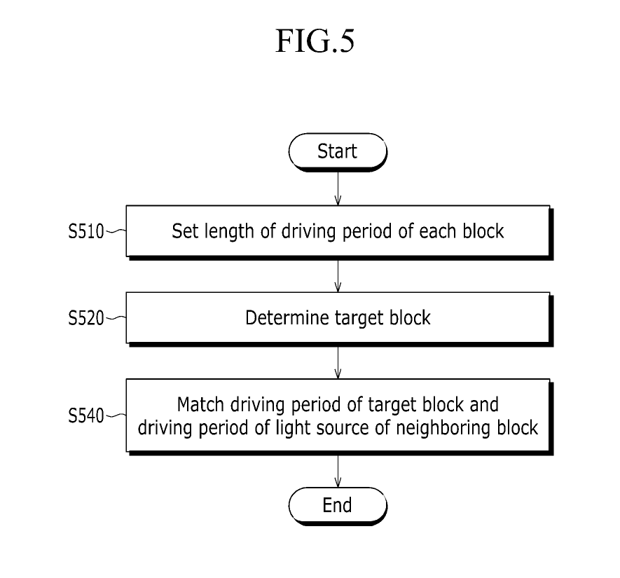

A driving method of a liquid crystal display according to an exemplary embodiment of the present invention will now be described with reference to FIGS. 5 to 8.

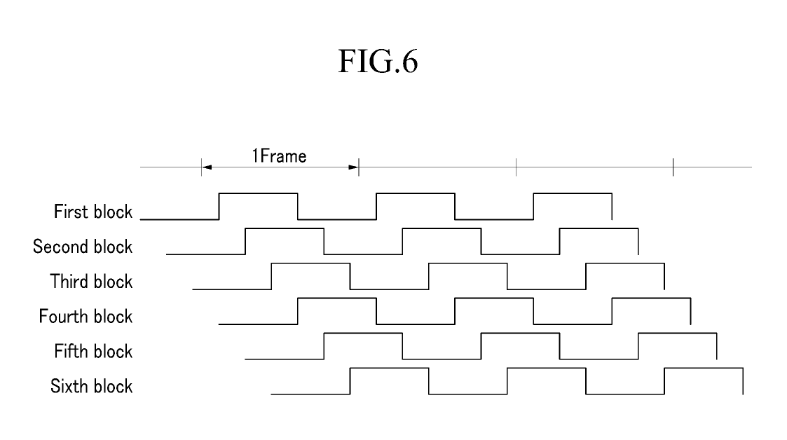

FIG. 5 is a flowchart of a driving method of a liquid crystal display according to an exemplary embodiment of the present invention. FIGS. 6 to 8 show driving timing of each block of a light source in the driving method of the liquid crystal display according to present exemplary embodiment.

The driving method of the liquid crystal display according to the exemplary embodiment will now be described considering that the driving method can be applied to the liquid crystal display of FIG. 1.

Referring to FIG. 5, a length of a period for driving a light source unit 900 of each block is set for dimming-driving (S510). Dimming driving is a technique to control the light amount of a light source considering luminance of an image to prevent a contrast ratio (CR) of the image from being decreased and to minimize power consumption. The CR of an image is the ratio of the luminace of the brightest color (e.g., white) to that of the darkest color (e.g., black) that the system is capable of producing. A high contrast ratio is a desired aspect of any display.

Data of a liquid crystal panel corresponding to a plurality of blocks is then analyzed to determine a block corresponding to a liquid crystal panel having the highest visibility as a target block (S520).

A period for driving a light source unit 900 of a target block and a light source unit 900 of its neighboring block are synchronized (S540).

Hereinafter, each step of the driving method will be described in further detail with reference to FIGS. 6 to 8.

As shown in FIG. 6, in driving of a light source unit 900 in one frame, light source units 901, . . . 906 are set to be sequentially driven from a first block to a sixth block. In the next frame, the light source units 901, . . . 906 are similarly set to be sequentially driven from the first block to the sixth block.

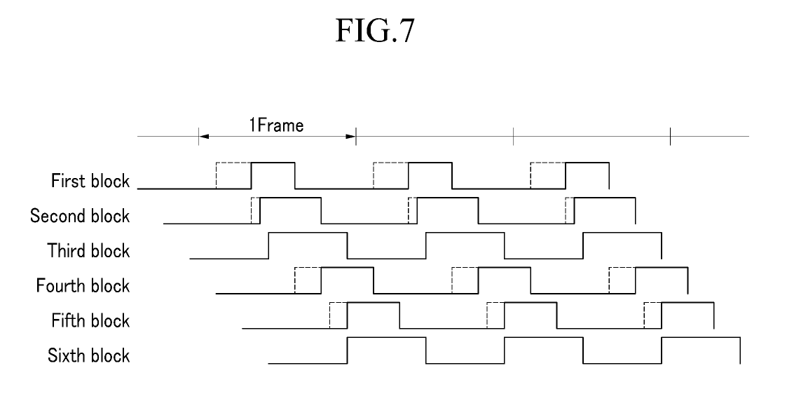

As shown in FIG. 7, for dimming-driving, data of a liquid crystal panel 300 corresponding to each of the first to sixth blocks is analyzed to set a length of a driving period of each of the first to sixth block light source units 901, 902, 903, 904, 905, 906. A portion marked by the dotted line denotes driving timing before changing the driving length of each of the first to sixth block light source units 901, 902, 903, 904, 905, 905, 906, and a portion marked by the solid line denotes the resultant driving timing after changing the driving period.

The dimming driving method can include a global dimming method in which the entire screen is a target, a 1-D local dimming method in which the screen is divided with respect to a longitudinal or latitudinal direction, a 2-D local dimming method in which the screen is divided into the x-axis and y-axis, a 3-D dimming method in which dimming is performed by using position information and color information, and a boosting method in which luminance is increased in a specific image to optimize emotional image quality such as adaptive luminance and power control (ALPC), wherein along with the amplification of the video-data backlight luminance is also increased such that the luminance of images is increased even more.

An average luminance value or a maximum luminance value of data of the liquid crystal panel 300 corresponding to the first block is calculated to generate the calculated value as a representative value of the first block. Likewise, the same calculation is performed for the second to sixth blocks to generate representative values of the second to sixth blocks. When the representative value is small, the length of a driving period of a light source unit 900 of the corresponding block is set to be short. To display a screen having high luminance, the length of the driving period of the light source unit 900 should be long, but when the luminance of the screen is low, the screen can be displayed with desired luminance while shortening the driving period of the light source unit 900 and power consumption can also be reduced.

In this case, when the maximum luminance value is set to a representative value, the length of a driving period of the light source unit is set corresponding to the maximum luminance value so that all the luminance values for the corresponding region of the corresponding frame can be properly expressed, but the reduction of power consumption is insignificant. That is, the length of the driving period of the light unit source 900 is set not only corresponding to the entirely bright screen but also corresponding to a partially bright screen.

When the average luminance value is set to the representative value, the length of the driving period of the light source unit 900 is short compared to the case that the maximum luminance value is set to the representative value so that a portion having high luminance in the corresponding region of the corresponding frame cannot be properly expressed. However, for an entirely dark and partially bright screen, the length of the driving period of the light source unit 900 is set to an average luminance value so that power consumption can be significantly reduced.

In the present exemplary embodiment, a representative value of the first block to a representative value of the sixth block are respectively generated to independently set the length of a driving period of each of the first to sixth block light source units 901, 902, 903, 904, 905, 906. This is for driving based on the local dimming method, but exemplary embodiments of the present invention are not limited thereto. Data of the entire liquid crystal panel 300 can be analyzed for driving based on the global-dimming method, and the length of the driving period of each of the first to sixth block light source units 901, 902, 903, 904, 905, 906 may be set to be equivalent to each other taking into consideration the luminance value of the entire screen of the corresponding frame.

Using the same method as the previous exemplary embodiment, data of the liquid crystal panel 300 corresponding to each of the first to sixth blocks is analyzed to determine a block corresponding to a portion that is better recognized by the human eyes than other portions in the screen of one frame, that is, a block corresponding to a portion having the highest visibility.

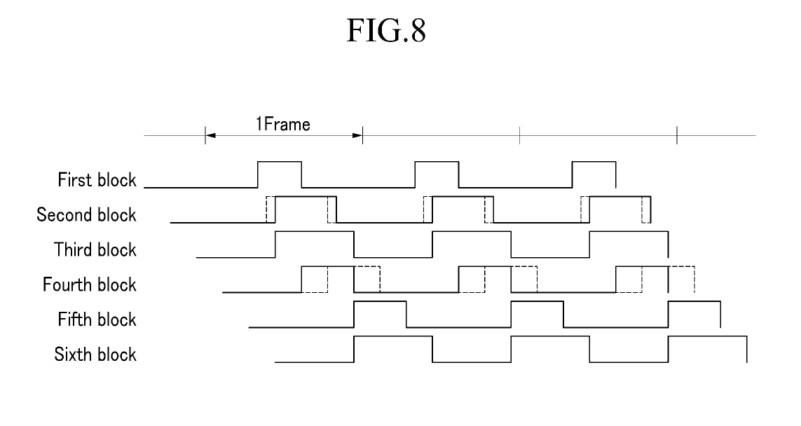

When the third block is determined to be a block having the highest visibility, the driving period of the third block light source unit 903 and driving periods of the second and fourth block light source units 902, 904 that neighbor the third block are synchronized as shown in shown in FIG. 8. Portions marked by the dotted line indicate driving timing before the synchronization of the driving periods of the second to fourth block light source units, and portions marked by the solid line indicate the resultant driving timing after the synchronization.

When the driving periods of the second to fourth block light source units 902, 903, 904 are different from each other in length, the start points and the finish points of all the driving periods cannot be synchronized. In this case, when the length of driving periods of the second block light source unit 902 and the fourth block light source unit 904 is shorter than the length of a driving period of the third block light source unit 903, a driving period of the second block light source unit 902 and the fourth block light source unit 904 may be included in the driving period of the third block light source unit 903. In addition, when the length of the driving periods of the second block light source unit 902 and the fourth block light source unit 904 is longer than the length of the driving period of the third block light source unit 903, the length of the driving periods of the second block light source unit 902 and the fourth block light source unit 904 may be set to overlap the driving period of the third block light source unit 903.

In the exemplary embodiment of the present invention, a light source unit of a block corresponding to a portion having the highest visibility and a light source unit 900 of its neighboring block are synchronized after setting the length of a driving period of a light source unit 900 of each block. However, exemplary embodiments of the present invention are not limited thereto, and the length of a driving period of a light source unit 900 of each block may be set after synchronizing a driving period of a light source unit 900 of a block corresponding to a portion having the highest visibility and driving periods of light source units 900 of neighboring blocks. However, the former one among the two methods can provide a movement distance for synchronization of driving periods of light source units 900 of the corresponding blocks being shorter.

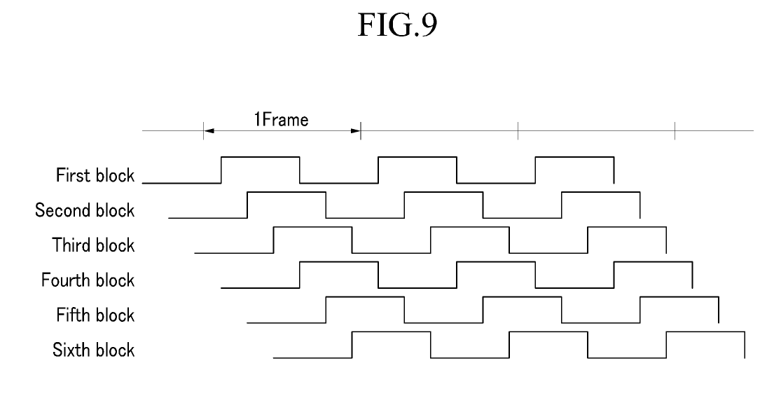

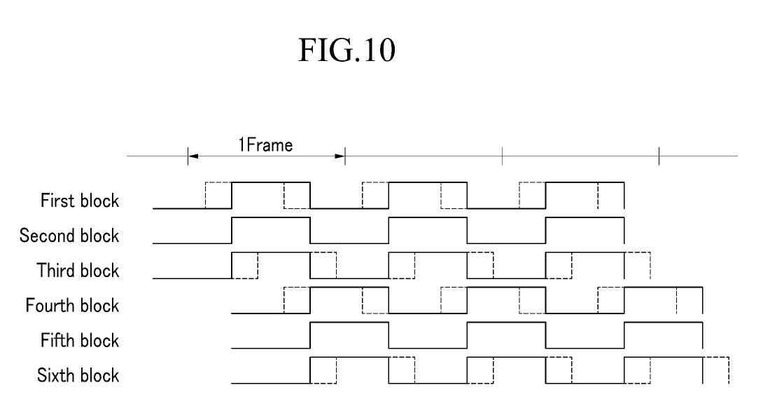

A driving method of a liquid crystal display according to an exemplary embodiment of the present invention will now be described with reference to FIG. 9 and FIG. 10 which show driving timing of each block of a light source unit in the driving method of the liquid crystal display according to an exemplary embodiment of the present invention.

The driving method of the liquid crystal display according to the exemplary embodiment can also be applied to the liquid crystal display of FIG. 1.

As in the first exemplary embodiment, a target block is determined, and a driving period of a light source unit of the target block and a driving period of a light source unit 900 of its neighboring block are synchronized in the present exemplary embodiment.

However, data of the liquid crystal panel is analyzed and a block corresponding to a portion having the highest visibility is determined as a target block in the first exemplary embodiment, but multiple target blocks are determined in the present exemplary embodiment. In this case, m blocks having visibility in sequence from highest visibility are determined as target blocks.

Hereinafter, each step of the driving method will be described in further detail with reference to FIG. 9 and FIG. 10.

As shown in FIG. 9, a light source unit 900 is set to be sequentially driven from a first block light source unit 901 to a sixth block light source unit 906 in one frame. In the next frame, the first block light source unit 901 to the sixth block light source unit 906 are set to be sequentially driven.

Data of liquid crystal panel 300 corresponding to each of the first to sixth blocks is analyzed, and two target blocks are selected in sequence from the highest visibility in the screen of one frame according to how well they are recognized by the human eyes.

When the second block is determined as a block having the highest visibility and the fifth block is determined as a block having the second highest visibility, a driving period of the second block light source unit 902 and driving periods of the first and third block light source units 901, 903 are synchronized as shown in FIG. 10. In addition, the driving period of the fifth block light source unit 905 is synchronized with driving periods of the fourth and sixth block light source units 904, 906. Portions marked by the dotted line indicate driving timing before synchronization of the driving periods of the first to third block light source units 901, 902, 903 and driving timing before synchronization of the driving periods of the fourth to sixth block light source units 904, 905, 906, and portions marked by the solid line indicate the resultant driving timing after the synchronization.

In the exemplary embodiment of the present invention, the light source unit is formed of six blocks, and two of the six blocks are determined as target blocks. However, the exemplary embodiment of the present invention is not limited thereto. The light source unit may be formed of more than two blocks, and two or more blocks may be selected as target blocks and driving periods of the target blocks may be synchronized with driving periods of their neighboring blocks.

The driving method of the liquid crystal display in accordance with an exemplary embodiment of the present invention may be applied to various light source units, and examples thereof follow.

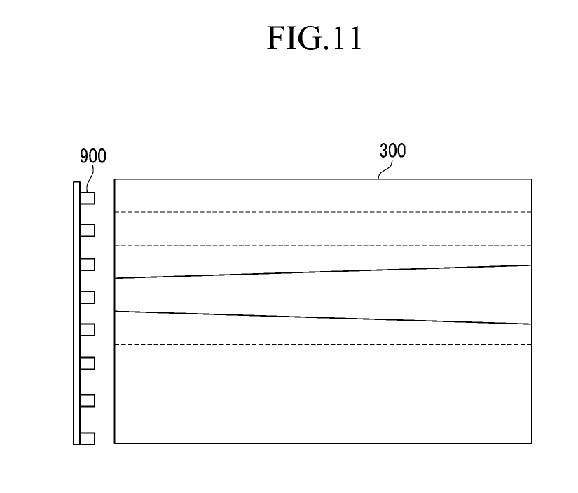

FIGS. 11 to 13 respectively show application examples of the driving method of the liquid crystal display in accordance with the present invention according to the type of light source unit.

A light source unit 900 can be classified into a side backlight type and a direct backlight type according to alignment. The light source unit 900 of FIG. 11 is a side backlight type that irradiates light to a liquid crystal panel 300 through a light guiding plate (not shown). The light source unit 900 supplies light to the inside of the liquid crystal panel 300, and the supplied light emits to the outside of the liquid crystal panel 300 such that an image is displayed.

The light source unit 900 is disposed along one side of the liquid crystal panel 300, and is formed of eight blocks. According to the driving method of the liquid crystal display in accordance with an exemplary embodiment of the present invention, blocks of the light source unit 900 are sequentially driven, and a driving period of a light source unit 900 of a block corresponding to a portion having the highest visibility is synchronized with a driving period of a light source unit 900 of its neighboring block.

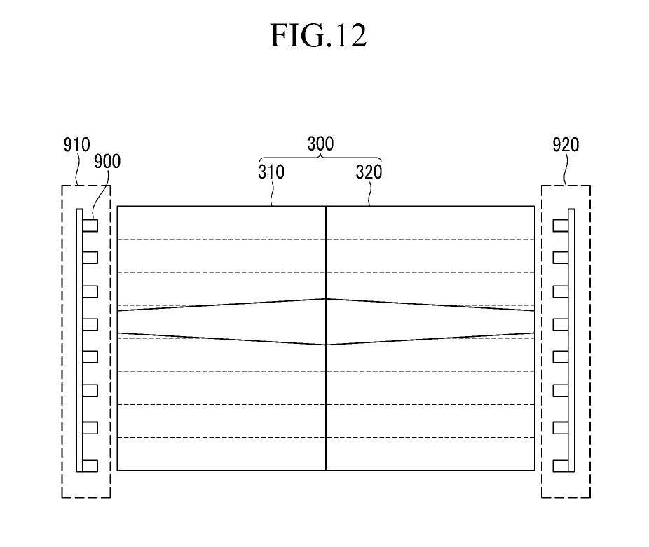

The light source unit 900 shown in FIG. 12 is also a side backlight type similar to the light source unit 900 shown in FIG. 11, but it irradiates light from both sides of the liquid crystal panel 300. The light source unit 900 is formed of a light source unit 910 in a first region formed along a first side of the liquid crystal panel 300, and a light source unit 920 of a second region formed along a second side thereof.

The light source unit 910 of the first region and the light source unit 920 of the second region are respectively divided into 8 blocks. The light source unit 910 of the first region and the light source unit 920 of the second region are independently driven.

The liquid crystal panel 300 is divided into a left-side region 310 and a right-side region 320. The left-side region 310 is further influenced by the first region light source unit 910 and the right-side region 320 is further influenced by the second region light source unit 920. A driving period of a first region light source unit 910 of a block corresponding to a portion having the highest visibility in the left-side region 310 is synchronized with a driving period of a first region light source unit 910 of a first block of its neighboring block. In addition, a driving period of a second region light source unit 920 of a block corresponding to a portion having the highest visibility in the right-side region 320 is synchronized with a driving period of a second region light source unit 920 of its neighboring block.

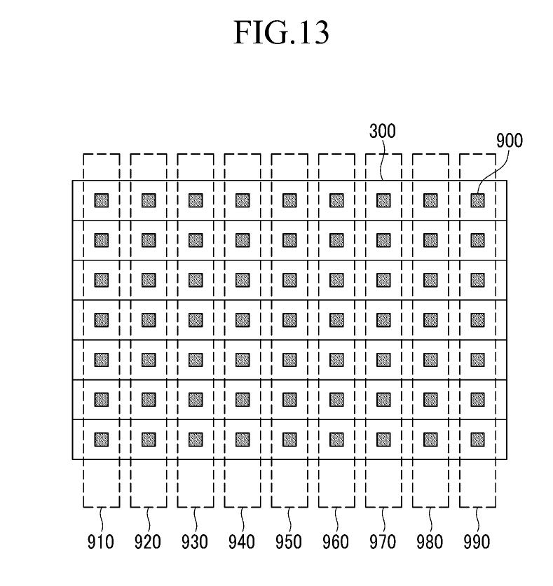

The light source unit 900 shown in FIG. 13 is a direct backlight type light source unit disposed in a matrix format right below the liquid crystal panel 300 and directly irradiates light to the light crystal panel 300. The light source unit 900 is divided into first to ninth region light source units 910, 920, 930, 940, 950, 960, 970, 980, 990 formed at a distance from each other from a lower portion of a first side of the liquid crystal panel 300 to a second side, facing the first side.

The first to ninth region light source units 910, 920, 930, 940, 950, 960, 970, 980, 990 are respectively divided into seven blocks. The first to ninth region light source units 910, 920, 930, 940, 950, 960, 970, 980, 990 are independently driven.

Since the light source unit 900 is divided into nine regions, the liquid crystal panel 300 corresponding thereto are also divided into 9 regions. A block corresponding to a portion having the highest visibility is determined for each region. A driving period of a light source unit 900 of the corresponding block is synchronized with driving periods of light source units 900 of neighboring blocks.

In addition, the light source unit 900 may be formed with various light sources including a light emitting diode (LED), an organic light emitting diode (OLED), a cold cathode fluorescent lamp (CCFL), an external electrode fluorescent (EEFL), and the like.

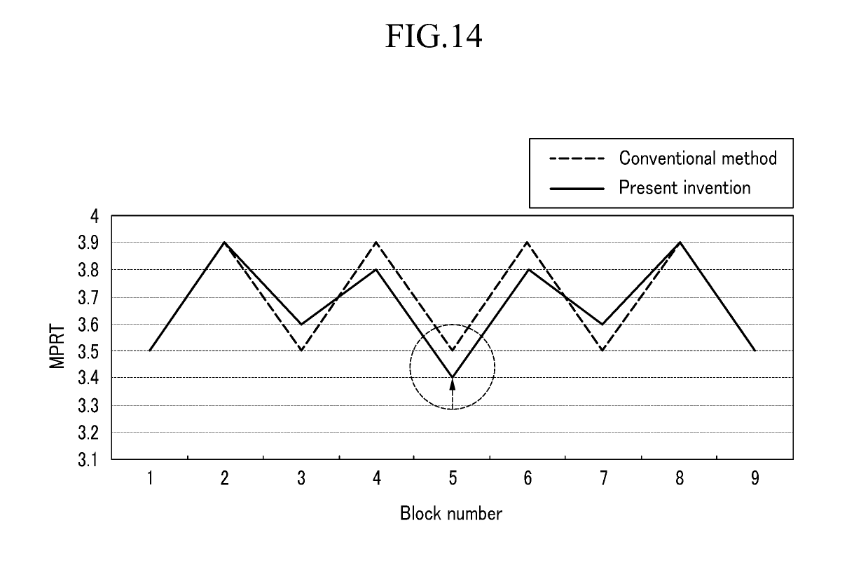

With reference now to FIG. 14, a graph shows the degree of echo phenomenon resulting from using the driving method of the liquid crystal display according to an exemplary embodiment of the present invention. The horizontal axis of the graph indicates a block number of a light source unit. The light source unit is divided into nine blocks, and the nine blocks are formed of a first block to a ninth block according to alignment of the blocks. The vertical axis indicates a motion picture response time (MPRT), and this implies a response speed with respect to replaying of a motion picture. When the MPRT is low, occurrence of the echo phenomenon is decreased.

As seen in FIG. 14, the MPRT, according to a driving method of a liquid crystal display of a conventional technique marked by the dotted line, is higher in the fourth, fifth, and sixth blocks than the MPRT according to the driving method of the liquid crystal display in accordance with an exemplary embodiment of the present invention marked by the solid line. The fifth block is a block corresponding to a portion having the highest visibility, and driving periods of light source units of the fourth and sixth blocks are not synchronized with a driving period of a light source unit of the fifth block such that the MPRT is increased in the fourth to sixth blocks. Accordingly, in accordance with the conventional method the echo phenomenon is increased in an image of the liquid crystal panel corresponding to the fourth to sixth blocks.

On the other hand, the MPRT according to the present invention is higher in the third and seventh blocks than the MPRT according to the conventional method. The third and seventh blocks correspond to a portion having relatively low visibility compared to the fifth block, and therefore the effect according to the decrease of the MPRT in the fourth to sixth blocks becomes more significant than the effect according to an increase of the MPRT in the third and seventh blocks. Accordingly, the improvement of the echo phenomenon becomes significant over the high visibility areas of the liquid crystal panel.

While the present invention has been described in connection with what is presently considered to be practical exemplary embodiments, it is to be understood that the invention is not limited to the disclosed embodiments, but, is also intended to cover various modifications and equivalent arrangements included within the spirit and scope of the appended claims.

What is claimed is:

1. A driving method of a liquid crystal display including a liquid crystal panel and a light source unit divided into a plurality of blocks and configured to irradiate light by a light source unit of a corresponding block being driven at a response time of liquid crystals of the liquid crystal panel, comprising:
analyzing data of a liquid crystal panel corresponding to the plurality of blocks to determine an n-th block corresponding to a portion having a highest visibility; and
synchronizing driving periods of light source units of the n-th block, an (n−1)-th block, and an (n+1)-th block.

2. The driving method of claim 1, wherein, the driving periods of the light source units of the (n−1)-th block and the (n+1)-th block are synchronized with the driving period of the n-th block.

3. The driving method of claim 2, wherein data of the liquid crystal panel corresponding to the (n−1)-th block has a highest luminance among data of the liquid crystal panels corresponding to the plurality of blocks.

4. The driving method of claim 2, wherein data of the liquid crystal panel corresponding to the n-th block has a highest luminance difference between a previous frame and a present frame among data of the liquid crystal panels corresponding to the plurality of blocks.

5. The driving method of claim 2, further comprising analyzing data of the liquid crystal panel to set a driving period for driving the light source unit.

6. The driving method of claim 5, wherein a length of the driving period of the light source unit is shortened as a luminance value of the data is decreased.

7. The driving method of claim 6, wherein the lengths of driving periods of a light source of each of the plurality of blocks are equivalent to each other.

8. The driving method of claim 5, wherein, the length of a driving period of a light source of a block is set to be short as a luminance value of data of a liquid crystal panel corresponding to the block is decreased.

9. The driving method of claim 8, wherein the length of a driving period of a light source unit of at least one block is different from the length of a driving period of a light source unit of another block.

10. The driving method of claim 1, wherein the light source unit is disposed at one side of the liquid crystal panel.

11. The driving method of claim 1, wherein a first light source unit is disposed at one side and a second light source is disposed at an opposing side of the liquid crystal panel.

12. The driving method of claim 11, wherein the first light source unit and the second light source unit respectively is divided into two regions, and light source units of a plurality of blocks included in each region are independently driven.

13. The driving method of claim 1, wherein the light source unit is disposed at a lower side of the liquid crystal panel.

14. The driving method of claim 13, wherein the light source unit is divided into a plurality of regions, and light source units of a plurality of blocks included in each region are independently driven.

15. The driving method of claim 1, wherein the light source unit is formed of at least one of a light emitting diode (LED), an organic light emitting diode (OLED), a cold cathode fluorescent lamp (CCFL), and an external electrode fluorescent lamp (EEFL).

16. A driving method of a liquid crystal display including a liquid crystal panel and a light source divided into a plurality of blocks and configured to irradiate light by a light source unit of a corresponding block at a response time of liquid crystals of the liquid crystal panel, comprising:
analyzing data of a liquid crystal panel corresponding to the plurality of blocks to determine a target block; and
synchronizing a driving period for driving a light source unit of the target block and driving periods for diving light source units of blocks neighboring the target block.

17. The driving method of claim 16, wherein the target block is a block corresponding to a portion having a highest visibility in the liquid crystal panel.

18. The driving method of claim 16, wherein multiple target blocks are provided.

19. The driving method of claim 18, wherein m blocks are determined as target blocks in sequence from the highest visibility in the liquid crystal panel.
